(19) United States
(12) Patent Application Publication
(10) Pub. No.: US 2026/0300482 A1
(43) Pub. Date: Oct. 1, 2026

(54) COMMUNICATION SYSTEM, COMMUNICATION DEVICE, COMMUNICATION METHOD, AND PROGRAM

(71) Applicant: RENESAS ELECTRONICS CORPORATION, Tokyo (JP)

(72) Inventor: Naoya KAWAI, Tokyo (JP)

(21) Appl. No.: 19/545,140

(22) Filed: Feb. 20, 2026

(30) Foreign Application Priority Data
Mar. 27, 2025 (JP) 2025-053501

(51) Int. Cl. G06F 21/55; G06F 1/04; G06F 13/42

(52) U.S. Cl. CPC G06F 21/554; G06F 1/04; G06F 13/4282; G06F 2213/0016; G06F 2221/034

(57) ABSTRACT

The communication system includes two or more first communication devices capable of operating as each of both a slave and a master, and a first communication path connecting among respective devices. A clock signal flows through the first communication path. The first communication device operating as a master transmits a clock signal to the first communication path. An alternative master, which is one of the first communication devices operating as a slave, detects an abnormality suspicion situation in the first communication device operating as a master, and if the abnormality suspicion situation is detected, switches to a mode for operating as a master to send a clock signal to the first communication path, and after transmitting the clock signal, if a clock signal is transmitted by another device, switches to a mode for operating as a slave.

### CROSS-REFERENCE TO RELATED APPLICATIONS

The disclosure of Japanese Patent Application No. 2025-053501 filed on Mar. 27, 2025, including the specification, drawings and abstract is incorporated herein by reference in its entirety.

### BACKGROUND

The present disclosure relates to a communication system, communication device, communication method, and program.

There are disclosed techniques listed below.

[Patent Document 1] Japanese Unexamined Patent Application Publication No. 2014-016907

A communication system composed of a master and slaves has been developed. For example, Patent Document 1 discloses a system in which a master and multiple slaves communicate according to the Inter-Integrated Circuit (I2C) protocol.

### SUMMARY

In a communication system, abnormalities may occur in the master. Patent Document 1 does not mention situations where abnormalities occur in the master. The embodiments described later have been made in view of such circumstances, and other problems and novel features will become apparent from the description herein and the accompanying drawings.

In a communication system according to one embodiment, one of the first communication devices operating as a slave detects a situation where there is a suspicion of an abnormality in the master, switches to a mode for operating as a master, and transmits a clock signal. Then, the first communication device returns to a mode for operating as a slave after another device transmits a clock signal.

According to the embodiment, a new technology is provided to address abnormalities in the master in a communication system including a master and slaves.

### BRIEF DESCRIPTION OF THE DRAWINGS

FIG. 1 is a diagram illustrating an overview of the operation of the communication system.

FIG. 2 is a block diagram illustrating the functional configuration necessary for the first communication device to operate as an alternative master.

FIG. 3 is a block diagram illustrating the hardware configuration of a computer implementing the first communication device.

FIG. 4 is a flowchart illustrating the process flow executed by the alternative master.

FIG. 5 is a diagram illustrating a communication system in which multiple first communication devices can operate as alternative masters.

### DETAILED DESCRIPTION

Below, embodiments of the present disclosure will be described in detail with reference to the drawings. In the drawings, the same or corresponding elements are denoted by the same reference numerals, and repetitive descriptions are omitted as necessary for clarity. Unless otherwise specified, predetermined values such as set values or thresholds are stored in advance in storage devices accessible by the devices using those values. Furthermore, unless otherwise specified, the storage unit is composed of one or more storage devices of any number.

### Summary

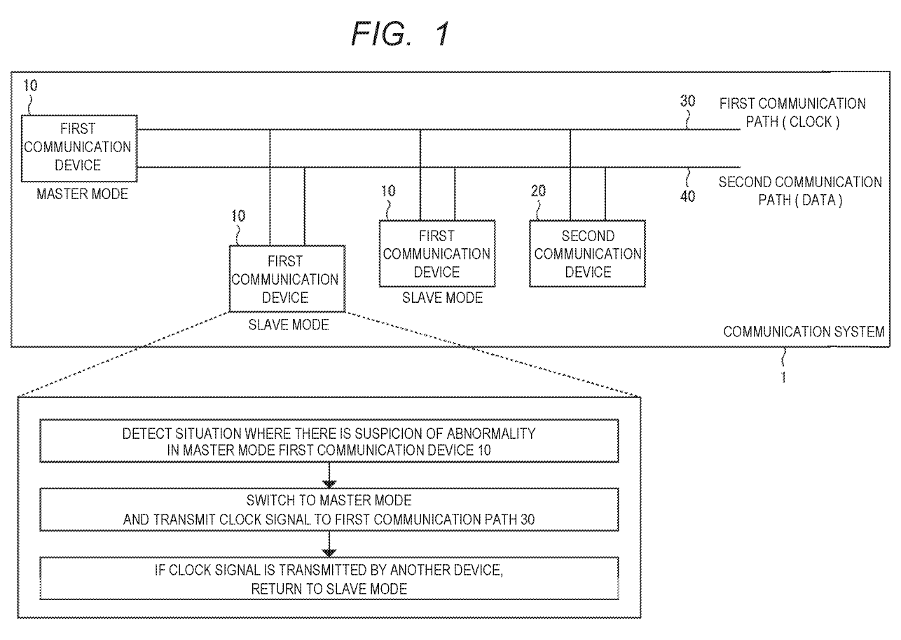

FIG. 1 is a diagram illustrating an overview of the operation of communication system 1. Here, FIG. 1 is a diagram to facilitate understanding of the overview of communication system 1, and the operation of communication system 1 is not limited to what is shown in FIG. 1.

Communication system 1 includes at least multiple first communication devices 10. First communication device 10 is a communication device capable of operating as each of both a master and a slave. Here, the first communication device 10 operating as a master is also referred to as ”master mode first communication device 10”. Similarly, the first communication device 10 operating as a slave is also referred to as ”slave mode first communication device 10”.

Normally, in communication system 1, two or more first communication devices 10 do not operate as masters simultaneously. In other words, under normal circumstances, only one first communication device 10 operates as a master at any given time.

Communication system 1 may include a second communication device 20 in addition to the first communication device 10. Second communication device 20 is a communication device that operates as a slave and cannot operate as a master.

Communication system 1 includes at least two communication paths: first communication path 30 and second communication path 40. The communication path is, for example, a bus. However, the communication path is not limited to a bus.

First communication path 30 is used for transmitting clock signals. Second communication path 40 is used for transmitting data signals. Both first communication path 30 and second communication path 40 perform data transmission and reception synchronized with the clock signal while the clock signal is flowing through first communication path 30. The clock signal is transmitted by the master mode first communication device 10.

Here, for some reason, the master mode first communication device 10 may cease to operate normally. Therefore, it is preferable for one of the slave mode first communication devices 10 to be able to operate as a backup master.

Thus, in communication system 1, if an abnormality occurs in the master mode first communication device 10, one of the slave mode first communication devices 10 switches to master mode and operates as an alternative master. Here, the first communication device 10 among the slave mode first communication devices 10 that switches to master mode is called an “alternative master”. The first communication device 10 operating as an alternative master among the slave mode first communication devices 10 may be predetermined or dynamically determined.

The alternative master operates as follows. First, the alternative master detects a situation where there is a suspicion of an abnormality in the master mode first communication device 10. Hereinafter, this situation is also referred to as an ”abnormality suspicion situation”. When an abnormality suspicion situation is detected, the alternative master switches to master mode and transmits a clock signal to first communication path 30. Hereinafter, the clock signal transmitted here is referred to as a “test clock signal”.

Here, the master mode first communication device 10 is configured to transmit a clock signal to first communication path 30 when it receives a clock signal transmitted by another first communication device 10. Therefore, when the test clock signal is transmitted by the alternative master, if the master mode first communication device 10 is normal, it transmits a clock signal to first communication path 30. From this, if no clock signal is transmitted by the master mode first communication device 10 when the test clock signal is transmitted by the alternative master, it can be said that the state of the master mode first communication device 10 is abnormal.

Therefore, the alternative master detects clock signals transmitted by other devices after transmitting the test clock signal. If no clock signal is transmitted by other devices, the alternative master determines that the master mode first communication device 10 is abnormal and maintains the alternative master’s own operation mode as master mode. On the other hand, if a clock signal is transmitted by other devices, the alternative master determines that the master mode first communication device 10 is normal and returns from master mode to slave mode.

For example, first communication device 10 is any computer that communicates according to the Improved Inter-Integrated Circuit (I3C) communication protocol. In this case, second communication device 20 is any computer that communicates according to the I2C communication protocol.

In a network where devices communicating according to I3C (hereinafter, I3C devices) and devices communicating according to I2C (hereinafter, I2C devices) coexist, one of the I3C devices operates as a master. And each I3C device other than the master, as well as each I2C device, operates as a slave. Each device operating as a slave performs data transmission and reception synchronized with the clock signal transmitted by the master.

Here, if the system is composed only of I2C devices, the I2C device can also operate as a master. Therefore, communication system 1 may be a system in which all first communication devices 10 are I2C devices and which does not include second communication device 20.

### Example of Effects

According to communication system 1, if an abnormality occurs in the master mode first communication device 10, the alternative master, which is one of the slave mode first communication devices 10, switches to master mode. Therefore, even if an abnormality occurs in the communication device operating as a master, communication system 1 as a whole can continue to operate.

Here, even if there is a suspicion of an abnormality in the master mode first communication device 10, it does not necessarily mean that the master mode first communication device 10 is truly in an abnormal state. For example, while high-load processing is being executed in the master mode first communication device 10, the clock signal may not be transmitted temporarily from the master mode first communication device 10.

In such a situation where the operation of the master mode first communication device 10 is only temporarily unstable, the first communication device 10 can continue to operate as a master. Therefore, if there is a suspicion of an abnormality in the master mode first communication device 10, it is preferable to check the state of the master mode first communication device 10.

According to communication system 1, when the alternative master detects a situation where there is a suspicion of an abnormality in the master mode first communication device 10, the alternative master switches to master mode and transmits a clock signal to confirm whether the master mode first communication device 10 is truly in an abnormal state. Then, if it is confirmed that the master mode first communication device 10 is normal, the alternative master returns to slave mode. Therefore, according to communication system 1, it is possible to prevent communication from being disabled in communication system 1 due to a master abnormality while preventing unnecessary changes of the master.

Below, communication system 1 of the present embodiment will be described in more detail.

### Example of Functional Configuration of First Communication Device 10

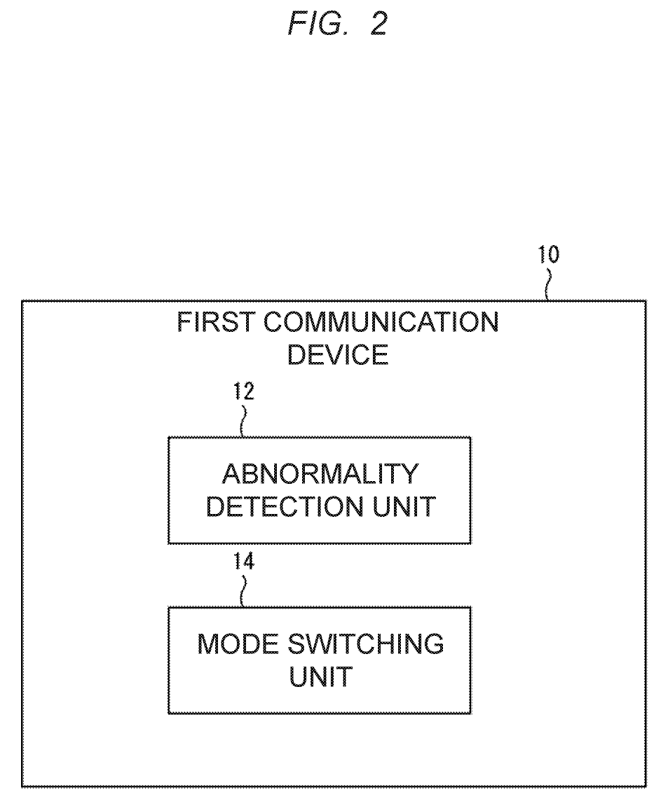

FIG. 2 is a block diagram illustrating the functional configuration necessary to operate as an alternative master among functional configurations of the first communication device 10. First communication device 10 includes an abnormality detection unit 12 and a mode switching unit 14. Abnormality detection unit 12 detects an abnormality suspicion situation. The mode switching unit 14 switches to the master mode in response to the detection of an abnormal suspicion situation. Subsequently, the abnormality detection unit 12 sends a test clock signal to the first communication path 30. Then, the abnormality detection unit 12 determines whether a clock signal has been sent by another device in response to the transmission of the test clock signal.

If a clock signal is sent by another device, the mode switching unit 14 switches to the slave mode. On the other hand, if no clock signal is sent by another device, the alternate master maintains the master mode.

The function to operate as an alternate master may be possessed by all first communication devices 10 or only some of them. In the latter case, the first communication device 10 that does not have the function to operate as an alternate master does not need to have each functional component shown in FIG. 2.

### Example of Hardware Configuration of the First Communication Device 10

For example, each functional component of the first communication device 10 is realized by hardware (e.g., hardwired electronic circuits) that implement each functional component.

Additionally, each functional component of the first communication device 10 can be realized by a combination of hardware and software (e.g., a combination of electronic circuits and programs that control them).

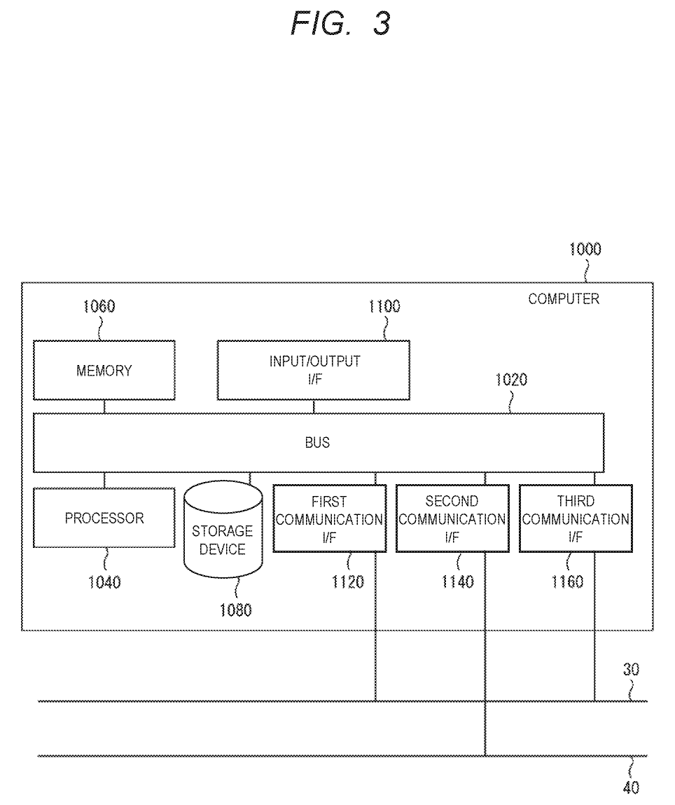

FIG. 3 is a block diagram illustrating the hardware configuration of a computer 1000 that implements the first communication device 10. The computer 1000 is any computer. For example, the computer 1000 is composed of integrated circuits (ICs) such as microcomputers or SoCs (System on Chip). The computer 1000 may be a dedicated computer designed to implement communication system 1 or a general-purpose computer.

For example, by installing a specific application on the computer 1000, each function of the first communication device 10 is realized on the computer 1000. The application is composed of programs to realize each functional component of the first communication device 10. The method of obtaining the program is arbitrary. For example, the program can be obtained from a storage medium (such as a DVD or USB memory) where the program is stored. Additionally, the program can be obtained by downloading it from a server device that manages the storage device where the program is stored.

The computer 1000 includes a processor 1040, a bus 1020, a memory 1060, a storage device 1080, an input/output interface (I/F) 1100, a first communication interface 1120, and a second communication interface 1140. The bus 1020 is a data transmission path for the processor 1040, memory 1060, storage device 1080, input/output interface 1100, first communication interface 1120, and second communication interface 1140 to send and receive data with each other. However, the method of connecting the processor 1040 and others is not limited to bus connections.

The processor 1040 is various processors such as an MPU (Micro Processing Unit), CPU (Central Processing Unit), GPU (Graphics Processing Unit), DSP (Digital Signal Processor), or FPGA (Field-Programmable Gate Array). The memory 1060 is a main storage device realized using RAM (Random Access Memory) or the like. The storage device 1080 is an auxiliary storage device realized e.g., using ROM (Read Only Memory), flash memory, or memory cards. The input/output interface 1100 is an interface for connecting the computer 1000 with input/output devices.

The first communication interface 1120 is an interface for connecting the computer 1000 to the first communication path 30. The second communication interface 1140 is an interface for connecting the computer 1000 to the second communication path 40.

Here, if the first communication device 10 is an I3C device, a third communication interface 1160 is further provided in the first communication device 10 so that the I3C device operating in master mode can receive clock signals. The I3C device operating in master mode uses the first communication interface 1120 to transmit clock signals. Therefore, another interface (i.e., the third communication interface 1160) is required to allow the I3C device operating in master mode to receive clock signals. The third communication interface 1160 is also connected to the first communication path 30, similar to the first communication interface 1120.

If an abnormal suspicion situation is detected, the alternate master I3C device sends a test clock signal from the first communication interface 1120. If the I3C device in master mode is normal, it receives the test clock signal at the third communication interface 1160. Then, the I3C device in master mode sends the clock signal from the first communication interface 1120. The alternate master I3C device receives the clock signal at the third communication interface 1160.

The storage device 1080 stores programs that realize each functional component of the first communication device 10 (programs that implement the aforementioned application). The processor 1040 realizes each functional component of the first communication device 10 by reading the programs stored in the storage device 1080 into memory 1060 and executing the programs.

The first communication device 10 may be realized by a single computer 1000 or by multiple computers 1000. In the latter case, for example, the first communication device 10 is composed of multiple SoCs or the like. In the latter case, the configuration of each computer 1000 does not need to be identical and can be different from each other.

In communication system 1, all first communication devices 10 may have the same configuration, or the configuration may differ for each first communication device 10. Additionally, the configuration of the second communication device 20 can be similar to that of the first communication device 10. However, the configuration of the second communication device 20 does not need to be completely identical to that of the first communication device 10.

### Flow of Processing

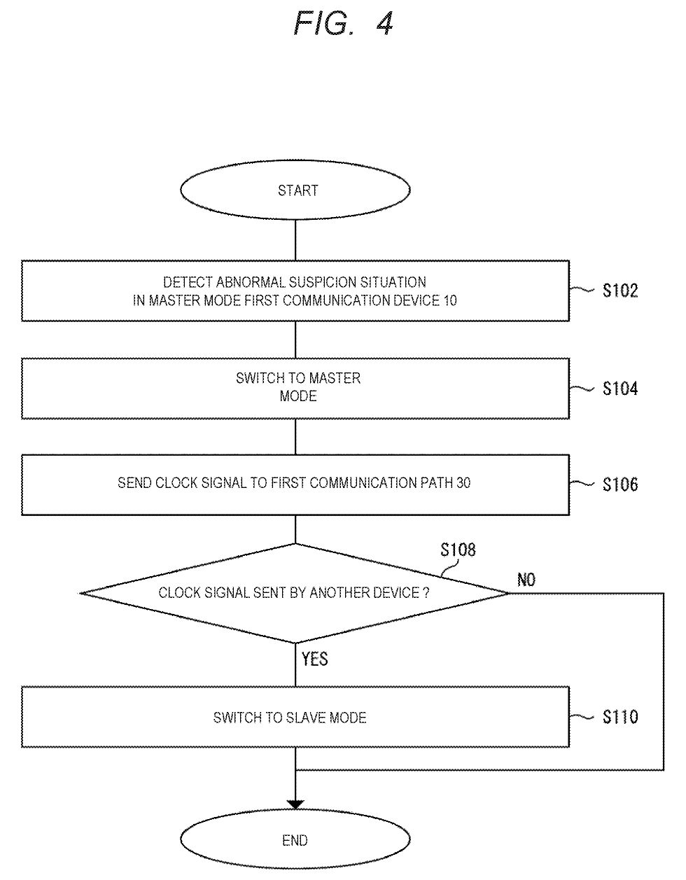

FIG. 4 is a flowchart illustrating the flow of processing executed by the alternate master. The abnormality detection unit 12 detects an abnormal suspicion situation (S102). If an abnormal suspicion situation is detected, the mode switching unit 14 switches to the master mode (S104). The abnormality detection unit 12 sends a test clock signal to the first communication path 30 (S106). After S106, the abnormality detection unit 12 determines whether a clock signal has been sent by another device (S108).

If a clock signal is sent by another device (S108:YES), the mode switching unit 14 switches the operation mode of the alternate master to slave mode (S110). On the other hand, if no clock signal is sent by another device (S108:NO), the alternate master ends the processing in FIG. 4. Therefore, if no clock signal is sent by another device, the alternate master continues to operate as a master.

### Detection of Abnormal Suspicion Situation: S102

The abnormality detection unit 12 detects an abnormal suspicion situation (i.e., a situation where there is a suspicion of abnormality in the first communication device 10 in master mode) (S102). There are various methods to detect an abnormal suspicion situation.

For example, the abnormality detection unit 12 detects a situation where no clock signal is detected from the first communication path 30 for a first predetermined time or more as an abnormal suspicion situation. Here, the clock signal is transmitted when data is being sent and/or received. Therefore, for example, the first predetermined time is predetermined based on the frequency of data transmission and reception in communication system 1. Additionally, the abnormality detection unit 12 may, for example, dynamically determine the first predetermined time based on the history of intervals of time when clock signals were received in the past.

If the first predetermined time is dynamically determined, for example, the abnormality detection unit 12 calculates a statistical value of the reception intervals for a predetermined number of clock signals most recently received and sets the statistical value as the first predetermined time. The statistical value may be e.g., a simple average, weighted average, maximum value, or minimum value. When a weighted average is used, it is preferable to set a larger weight for the reception intervals of clock signals received at times closer to the present. This allows newer reception intervals to be treated as more important information.

A situation where no clock signal is detected for the first predetermined time or more can be detected using a timer, for example. First, the abnormality detection unit 12 sets a timer set to the first predetermined time. If the abnormality detection unit 12 detects a clock signal before the timer is triggered, the abnormality detection unit 12 resets the timer setting. That is, the remaining time of the timer is set again to the first predetermined time.

In this way, when the timer is set, it triggers if a clock signal is not detected even once for the first predetermined time. Therefore, the abnormality detection unit 12 can recognize that the clock signal has not been detected for the first predetermined time or more when the timer is triggered. Thus, the abnormality detection unit 12 determines that the current situation is an abnormal suspicion situation when the timer is triggered.

### Switching to Master Mode: S104

When an abnormal suspicion situation is detected, the mode switching unit 14 switches the operation mode of the alternative master to the master mode. Here, in a device with multiple operation modes, any method can be adopted to switch the operation mode.

### Abnormality Detection: S106, S108

After switching to master mode, the abnormality detection unit 12 sends a test clock signal to the first communication path 30 (S106). The abnormality detection unit 12 determines whether a clock signal has been sent by another device after sending the test clock signal (S108).

For example, the abnormality detection unit 12 determines whether a clock signal has flowed through the first communication path 30 within the second predetermined time after the test clock signal has been sent (in other words, after the test clock signal has finished flowing through the first communication path 30). If the first communication device 10 in master mode sends a clock signal in response to receiving the test clock signal, the clock signal flows after the test clock signal is sent.

Therefore, if the clock signal flows through the first communication path 30 within the second predetermined time after the test clock signal is sent (S108:YES), the abnormality detection unit 12 determines that the first communication device 10 in master mode is not abnormal.

On the other hand, if the clock signal does not flow through the first communication path 30 within the second predetermined time after the test clock signal is sent (S108:NO), the abnormality detection unit 12 determines that the first communication device 10 in master mode is abnormal.

### About the Test Clock Signal

When the clock signal flows through the first communication path 30, the first communication device 10 and the second communication device 20 treat the signal flowing through the second communication path 40 as a data signal. Therefore, it is preferable to ensure that each device included in the communication system 1 does not receive incorrect data while the test clock signal flows through the first communication path 30.

Thus, when sending the test clock signal, the abnormality detection unit 12 sends a data signal representing data that is not received by any device included in the communication system 1 to the second communication path 40. By doing so, the alternative master can replace the first communication device 10 in master mode without adversely affecting other devices.

Specifically, the data sent by the abnormality detection unit 12 indicates a destination in the header that does not apply to any device included in the communication system 1. Each device included in the communication system 1 is configured not to receive the payload of the data represented by the data signal if the destination indicated in the header of the data received from the second communication path 40 is not itself.

The abnormality detection unit 12 generates data using a header in which a value different from the identifier of any device included in the communication system 1 is set as the destination. Then, the abnormality detection unit 12 sends a data signal representing the data. The value set in the payload of the data is arbitrary.

To achieve the aforementioned header setting, the identifiers of each device included in the communication system 1 are stored in advance in a storage unit accessible by the abnormality detection unit 12. The abnormality detection unit 12 identifies the identifiers of each device included in communication system 1 by referring to the information stored in the storage unit.

### Switching to Slave Mode: S110

If a clock signal is sent by another device after the test clock signal is sent (S108:YES), the mode switching unit 14 switches the operation mode of the alternative master to slave mode (S110). As mentioned earlier, any method can be adopted to switch the operation mode in a device with multiple operation modes.

Here, the first communication device 10 in normal master mode that received the test clock signal sends a data signal representing data that is not received by any device included in the communication system 1 to the second communication path 40 when sending the clock signal. The method for sending a data signal that is not received by any device is as described above. To achieve the sending of the data signal, the identifiers of each device included in communication system 1 are also stored in advance in a storage unit accessible by the first communication device 10 in master mode.

### Method for Determining the Alternative Master

There are various methods for determining the first communication device 10 that operates as an alternative master. For example, the first communication device 10 that operates as an alternative master is predetermined. Additionally, for example, the first communication device 10 that operates as an alternative master may be determined dynamically.

In the latter case, for example, each first communication device 10 is configured to operate as an alternative master at random timings. More specifically, each first communication device 10 detects abnormal suspicion situations. Then, each first communication device 10 sends the test clock signal and performs subsequent processing (i.e., processing from S104 to S108) after a margin time, which is determined randomly, has elapsed following the detection of an abnormal suspicion situation. In this case, the first communication device 10 that sent the test clock signal before all other devices functions as the alternative master.

It is not preferable that multiple first communication devices 10 operate as alternative masters. Therefore, for example, each first communication device 10 calculates the aforementioned margin time as r*T, where r is a random value and T is the predicted time required for abnormality detection by a first communication device 10. By doing so, it is considered that no other first communication device 10 will operate as an alternative master until the first communication device 10 that first sent the test clock signal completes its operation as an alternative master. The predicted time T is assumed to be set in advance.

### Regarding the Replacement of the Alternative Master

It is also conceivable that the alternative master, which has switched to master mode, may become abnormal like the original master. Therefore, a first communication device 10 that further replaces the alternative master may be prepared.

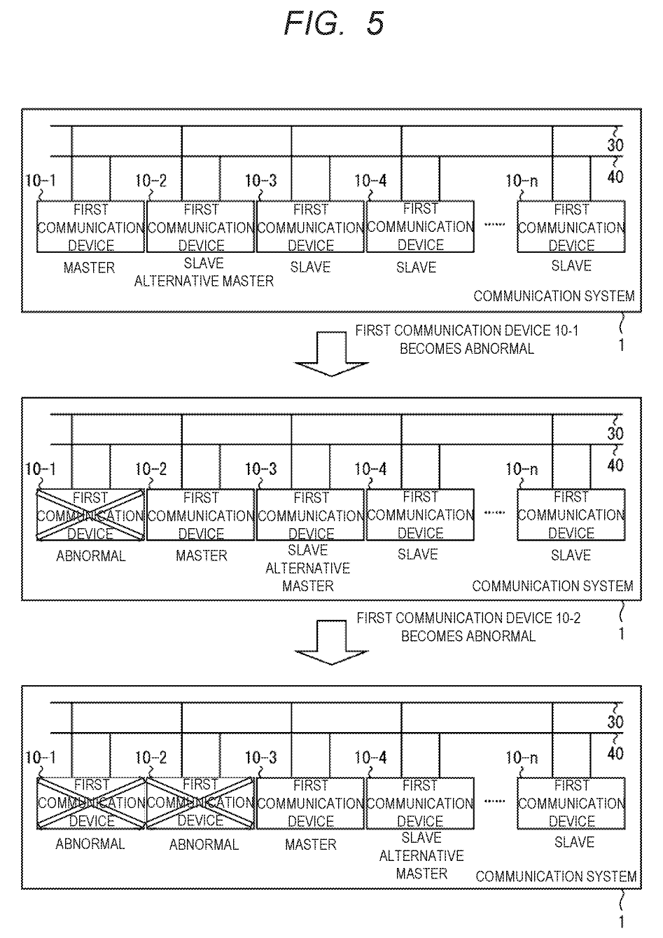

FIG. 5 is a diagram illustrating a communication system 1 in which multiple first communication devices 10 can operate as alternative masters. In FIG. 5, communication system 1 has n first communication devices 10 (i.e., from first communication device 10-1 to first communication device 10-n). In this example, the first communication device 10-i (where i is an integer of 2 or more) operates as an alternative master for the first communication device 10-(i-1). For example, if the first communication device 10-1 is operating in master mode, the first communication device 10-2 operates as an alternative master. Also, if the first communication device 10-2 is operating in master mode, the first communication device 10-3 operates as an alternative master.

First, the first communication device 10-1 operates in master mode initially. Subsequently, if the first communication device 10-1 becomes abnormal, the first communication device 10- 2 detects the abnormality and switches to master mode. Then, the first communication device 10-3 operates as an alternative master.

Subsequently, if the first communication device 10-2 becomes abnormal, the first communication device 10-3 detects the abnormality and switches to master mode.

In this way, by having multiple first communication devices 10 operate sequentially as alternative masters, the probability of continuing operation of the entire communication system 1 is higher compared to when only one first communication device 10 operates as an alternative master.

The present disclosure has been described with reference to the embodiments above, but it is not limited to the embodiments described above. Various changes can be made to the configuration and details of the present disclosure within the scope of the present disclosure as understood by those skilled in art. Each embodiment can be combined with other embodiments as appropriate.

Each drawing is merely illustrative for explaining one or more embodiments. Each drawing is not associated with only one specific embodiment but may be associated with one or more other embodiments. As understood by those skilled in the art, various features or steps described with reference to any one drawing can be combined with features or steps shown in one or more other drawings to create embodiments not explicitly illustrated or described. Not all features or steps shown in any one drawing to describe exemplary embodiments are necessarily essential, and some features or steps may be omitted. The order of steps described in any drawing may be changed as appropriate.

In the present disclosure, the program includes a set of instructions (or software code) for causing the computer to perform one or more functions described in the embodiments when loaded into the computer. The program may be stored in a non-transitory computer-readable medium or a tangible storage medium. By way of example and not limitation, computer-readable media or tangible storage media include random-access memory (RAM), read-only memory (ROM), flash memory, solid-state drive (SSD) or other memory technologies, CD-ROM, digital versatile disc (DVD), Blu-ray (registered trademark) disc or other optical disc storage, magnetic cassettes, magnetic tape, magnetic disk storage or other magnetic storage devices. The program may be transmitted on transitory computer-readable media or communication media. By way of example and not limitation, transitory computer-readable media or communication media include electrical, optical, acoustic, or other forms of propagated signals.

### Additional Statement

### Additional Statement 1

A communication system comprising:
two or more first communication devices capable of operating as each of a slave and a master; and
a first communication path connecting among respective devices, wherein a clock signal flows through the first communication path,
wherein the first communication device operating as a master transmits a clock signal to the first communication path; and
wherein an alternate master, which is one of the first communication devices operating as a slave:
detects an abnormality suspicion situation with suspected abnormality in the first communication device operating as a master;
if the abnormality suspicion situation is detected, switches to a mode for operating as a master and transmits a clock signal to the first communication path; and
after the transmission of the clock signal, if a clock signal is transmitted from another device, switches to a mode for operating as a slave.

### Additional Statement 2

The communication system according to additional statement 1, wherein the alternate master continues to operate as a master if no clock signal is transmitted from another device after the transmission of the clock signal.

### Additional Statement 3

The communication system according to additional statement 1, wherein the alternate master detects a situation where a clock signal is not received for a predetermined time or more as the abnormality suspicion situation.

### Additional Statement 4

The communication system according to additional statement 3, wherein the alternate master determines the predetermined time based on the reception interval of previously received clock signals.

### Additional Statement 5

The communication system according to additional statement 1, further comprising a second communication path connecting among respective devices, wherein a data signal flows through the second communication path;
wherein the alternate master transmits a data signal, whose destination is not any device included in the communication system, to the second communication path if the abnormality suspicion situation is detected.

### Additional Statement 6

The communication system according to additional statement 1, wherein, after the alternate master switches to a mode for operating as a master, one of the first communication devices operating as a slave:
detects the abnormality suspicion situation regarding the alternate master;
if the abnormality suspicion situation is detected regarding the alternate master, switches to a mode for operating as a master and transmits a clock signal to the first communication path; and
if a clock signal is transmitted from another device after the transmission of the clock signal, switches to a mode for operating as a slave.

### Additional Statement 7

The communication system according to additional statement 1, further comprising one or more second communication devices that do not operate as a master but operate as a slave,
wherein each of the first communication devices communicates according to the Improved Inter-Integrated Circuit protocol; and
wherein each of the second communication devices communicates according to the Inter-Integrated Circuit protocol.

### Additional Statement 8

A communication device connected to multiple other communication devices via a communication path through which a clock signal flows,
wherein one of the other communication devices: operates as a master; detects an abnormality suspicion situation with suspected abnormality in the other communication device operating as a master;
if the abnormality suspicion situation is detected, switches to a mode for operating as a master and transmits a clock signal to the communication path; and
after the transmission of the clock signal, if a clock signal is transmitted from the other communication device, switches to a mode for operating as a slave.

### Additional Statement 9

A communication method executed by a computer, wherein the computer is connected to multiple communication devices via a communication path through which a clock signal flows, and one of the communication devices operates as a master, the method comprising, by the computer:
detecting an abnormality suspicion situation with suspected abnormality in the communication device operating as a master;
if the abnormality suspicion situation is detected, switches to a mode for operating as a master and transmits a clock signal to the communication path; and
after transmitting the clock signal, if a clock signal is sent from the communication device, switches to a mode for operating as a slave.

### Additional Statement 10

A program executed by a computer, wherein the computer is connected to multiple communication devices via a communication path through which a clock signal flows, one of the communication devices operating as a master,
wherein the program causes the computer to: detect an abnormality suspicion situation in the communication device operating as a master,
switch, if the abnormality suspicion situation is detected, to a mode for operating as a master and send a clock signal to the communication path; and
switch, after sending the clock signal, if a clock signal is sent from the communication device, to a mode for operating as a slave.

### Additional Statement 11

A communication system comprising:
two or more first communication devices capable of operating as each of a slave and a master;
a first communication path connecting among respective devices,
wherein a clock signal flows through the first communication path;
wherein the first communication device operating as a master transmits a clock signal to the first communication path; and wherein the first communication device includes a memory in which instructions are stored and a processor that executes the instructions; and
wherein the processor of one of the first communication devices operating as a slave is configured to execute the instructions to:
detect an abnormality suspicion situation in the first communication device operating as a master;
switch, if the abnormality suspicion situation is detected, to a mode for operating as a master and transmit a clock signal to the communication path; and
switch, if a clock signal is transmitted by another device after the transmission of the clock signal, to a mode for operating as a slave.

Some or all of the elements described in Additional statements 2 to 7, which are subordinate to Additional statement 1 (e.g., configuration and function), may also be subordinate to each of Additional statements 8 to 11 in a similar subordinate relationship as Additional statements 2 to 7. Some or all of the elements described in any additional statement may be applied to various hardware, software, recording units for recording software, systems, and methods.

What is claimed is:

1. A communication system comprising:
two or more first communication devices capable of operating as each of a slave and a master; and
a first communication path connecting among respective devices, wherein a clock signal flows through the first communication path,
wherein the first communication device operating as a master transmits a clock signal to the first communication path; and
wherein an alternate master, which is one of the first communication devices operating as a slave:
detects an abnormality suspicion situation with suspected abnormality in the first communication device operating as a master;
if the abnormality suspicion situation is detected, switches to a mode for operating as a master and transmits a clock signal to the first communication path; and
after the transmission of the clock signal, if a clock signal is transmitted from another device, switches to a mode for operating as a slave.

2. The communication system according to claim 1, wherein the alternate master continues to operate as a master if no clock signal is transmitted from another device after the transmission of the clock signal.

3. The communication system according to claim 1, wherein the alternate master detects a situation where a clock signal is not received for a predetermined time or more as the abnormality suspicion situation.

4. The communication system according to claim 3, wherein the alternate master determines the predetermined time based on the reception interval of previously received clock signals.

5. The communication system according to claim 1, further comprising a second communication path connecting among respective devices, wherein a data signal flows through the second communication path;
wherein the alternate master transmits a data signal, whose destination is not any device included in the communication system, to the second communication path if the abnormality suspicion situation is detected.

6. The communication system according to claim 1, wherein, after the alternate master switches to a mode for operating as a master, one of the first communication devices operating as a slave:
detects the abnormality suspicion situation regarding the alternate master;
if the abnormality suspicion situation is detected regarding the alternate master, switches to a mode for operating as a master and transmits a clock signal to the first communication path; and
if a clock signal is transmitted from another device after the transmission of the clock signal, switches to a mode for operating as a slave.

7. The communication system according to claim 1, further comprising one or more second communication devices that do not operate as a master but operate as a slave,
wherein each of the first communication devices communicates according to the Improved Inter-Integrated Circuit protocol; and
wherein each of the second communication devices communicates according to the Inter-Integrated Circuit protocol.

8. A communication device connected to multiple other communication devices via a communication path through which a clock signal flows,
wherein one of the other communication devices:
operates as a master;
detects an abnormality suspicion situation with suspected abnormality in the other communication device operating as a master;
if the abnormality suspicion situation is detected, switches to a mode for operating as a master and transmits a clock signal to the communication path; and
after the transmission of the clock signal, if a clock signal is transmitted from the other communication device, switches to a mode for operating as a slave.

9. A communication method executed by a computer, wherein the computer is connected to multiple communication devices via a communication path through which a clock signal flows, and one of the communication devices operates as a master, the method comprising, by the computer:
detecting an abnormality suspicion situation with suspected abnormality in the communication device operating as a master;
if the abnormality suspicion situation is detected, switches to a mode for operating as a master and transmits a clock signal to the communication path; and
after transmitting the clock signal, if a clock signal is sent from the communication device, switches to a mode for operating as a slave.
